(19) United States
(12) Patent Application Publication
(10) Pub. No.: US 2006/0040126 A1
(43) Pub. Date: Feb. 23, 2006

(54) Electrolytic alloys with co-deposited particulate matter

(76) Inventors: Rick Allen Richardson, Dayton, OH (US); Daniel A. Brockman, Dayton, OH (US)

Correspondence Address: DINSMORE & SHOHL LLP;One Dayton Centre, One South Main Street, Suite 1300, Dayton, OH, 45402-2023, US

(21) Appl. No.: 11/112,227

(22) Filed: Apr. 22, 2005

Related U.S. Application Data
(60) Provisional application No. 60/602,488, filed on Aug. 18, 2004.

(51) Int. Cl. B32B 15/00; C25C 1/24

(52) U.S. Cl. 428/615; 205/365; 205/557

(57) ABSTRACT

Amorphous nickel phosphorous alloys, amorphous nickel cobalt phosphorous alloys, or amorphous cobalt phosphorous alloys, all of which are co-deposited with particulate matter. Articles and/or devices formed by electroplating the amorphous phosphorous alloys co-deposited with particulate matter onto a substrate surface.

### CROSS REFERENCE TO RELATED APPLICATIONS

This application claims the benefit of provisional application No. 60/602488 filed on Aug. 18, 2004.

### FIELD OF THE INVENTION

The present invention relates to certain novel amorphous phosphorous alloys co-deposited with particulate matter, and, in particular, relates to amorphous nickel phosphorous, amorphous cobalt phosphorous and amorphous nickel cobalt phosphorous alloys, all of which are co-deposited with particulate matter.

### BACKGROUND OF THE INVENTION

Articles and devices formed from metal or having metal surfaces or coatings thereon have numerous applications and have found widespread use in a variety of industries. Depending upon the intended end-use of the metal article or metal-coated article, it is desirable that the surface metal exhibit a particular property or combination of properties.

For example, there has always been a great need to improve the wear and abrasion resistance of manufactured articles for various applications. Typically, the most cost effective method to date is to coat the articles with another material that is harder, has a higher lubricity or a different geometrical structure than the base metal to obtain the desired results. The most common practice used today and in the past is to coat the article with a layer of hard chromium. This coating works well in most applications; although, it does not possess all the necessary properties for superior optical surfaces. However, it has recently been discovered that components utilized in the chromium process potentially contain components harmful to the environment and may pose a safety hazard to those exposed to the solutions.

Other methods utilized to improve the wear and abrasion resistance of the manufactured article are flame spraying, chemical vapor deposition (CVD) and physical vapor deposition (PVD). Flame spraying comprises flame spraying a variety of metal alloys onto the base metal of the manufactured article. Those skilled in the art will appreciate typical problems associated with this method which result in the article's inherent porosity and the method being limited only to line of sight operation. Typical drawbacks to CVD and PVD technologies include the expense of the method and the method being limited to line of sight operation.

Further, the fabrication of high precision devices such as photographic and instrument lenses (Fresnel lenses, lenticular and rotogravure cylinders) as well as molds for optical products and information storage disks, requires that the device or the surface of the device be formed of a material which is very hard (to resist scratching), chemically inert in its ordinary environment (to prevent rusting, oxidation or tarnish which renders the surface unacceptable), and of suitable metallurgical purity (of a highly regular and dense-grain structure-free of slag, impurities, voids, or other unacceptable microflaws).

Initially, these high precision devices were commonly made of a monolithic metal such as aluminum, copper and certain grades of stainless steel and were fabricated in all the usual ways well known to the metal working industry, including metal removal via milling, grinding, lathe turning, fly cutting, or spark erosion by electrical discharge. Once the nominal dimensions, shape or contour of the fabricated device had been attained, the surface of the device was abrasively lapped by successively finer abrasives in a manner well known to those skilled in the art until the contoured surfaces reached satisfactory degrees of smoothness and polish.

More recently, in order to obtain the precision needed, the surface of the device has been machined by a technique known as single-point diamond turning. Single-point diamond turning is accomplished by taking a diamond crystal of the desired size and shape and combining with high precision machines, that may utilize either liquid or gas bearings in controlled environmental conditions, to produce superior quality optical components. This technology is an improvement over the above-mentioned methods that involve grinding, machining and polishing. Those methods are very time consuming, labor intensive and can lead to defects such as deformation and aberrations in the device surface. With diamond turning the tool is so hard and sharp that when very thin layers are cut into certain materials there is minimal edge contact and stress and friction applied to the material are at an absolute minimum. This results in a spectacular finish and a contour that is an exact replica of the tool path.

A problem with single-point diamond turning is the rapidity with which the diamond turning tool wears out. Diamond turning large molds or lenticular rolls that may require hundreds of miles of diamond turning length is particularly problematic from a tool wear standpoint. In addition, although this method of producing precision tooled devices works well, the number of materials with which is it compatible are limited. The materials that have found wide spread existence in the industry today mostly include but are not limited to aluminum, copper, certain grades of stainless steel and electroless nickel/phosphorous alloy.

Although aluminum and copper seem to produce acceptable results, both metals have a microcrystalline grain structure which makes it harder to attain the required surface finish. Both metals are also very soft which makes them susceptible to damage at the slightest contact. Both metals are also very reactive which can lead to severe corrosion even in the mildest of environments.

Stainless steels also have the same crystalline structure problems and because of the is hardness of this material, along with the crystal structure, causes the degradation of the diamond tool very quickly and is difficult and time consuming to polish.

High phosphorous electroless nickel deposits (≧10%) on a base metal substrate gives a surface which seems to have all the desired characteristics for a superior diamond turning material. They are reported as being completely amorphous in structure (no crystalline or grain structure discernible at 150,000×), have reasonable hardness (48-52 Rc) and a natural lubricity or low coefficient of friction that extends diamond tool life. The draw backs of this deposit are with the method, expense and limitations of the deposition process. (The solution chemistry is fairly expensive and at times can be hard to control as the reaction mechanisms are very complex and still to this day are not fully understood.) In addition, high phosphorous electroless nickel deposits typically contain 10-11.5% phosphorous content, with a maximum of 13% being claimed. Nickel/phosphorous alloys having a phosphorous content of between about 10% and about 13% can become slightly magnetic when exposed to temperatures in the range of 250° C. and 300° C. Such temperatures are typically encountered in the manufacture of memory disks. Therefore, memory disks manufactured using nickel/phosphorous alloys having a phosphorous content of between about 10% and about 13% may become slightly magnetic during the manufacturing process and must be rejected. Moreover, because the deposit is laminar in structure, the deposit quality varies greatly with varying layers containing different amounts of phosphorous. This results in a tendency for “banding” or demarcation lines to appear after diamond turning. This can be caused by solution chemistry imbalance (wetting and dispersion agents) and because of the slow deposition rate (0.0002″-0.0005″ per hr.). The pretreatment cycle for most materials also has to be perfect as the operating solution has a pH that is close to neutral and does not offer any cleaning or oxide removal help the moment before deposition starts. Also because of the above problems and the tendency for the solution to want to plate the related process equipment it is very difficult to obtain high quality deposits over 0.008″-0.010″ thick. In addition, it has also been found that electroless nickel deposits may contain discrete cites of crystalline structures which are problematic for diamond turning applications.

As an alternative to the formation of high precision devices by diamond tooling, a high precision device could be made by plating a substrate mandrel which has a precisely-dimensioned surface with a metal or metal alloy suitable for use in high precision devices (i.e., very hard, chemically inert, suitable metallurgical purity), and then separating the metal or metal alloy from the substrate mandrel to give the high precision device. The initial layer of deposit formed would be an exact replica of the precisely-dimensioned substrate mandrel surface and would therefore itself be precisely dimensioned, making it suitable as a high precision device without further fabrication. However, most metals or metal alloys which are suitable for the use in making high precision devices are not well-suited to this electroforming technique in that they exhibit internal stresses which are too great to allow the electroformed metal or alloy to be separated from the substrate mandrel without distortion.

Recently, the present inventors have invented electrolytic amorphous non-laminar phosphorous alloys and the processes for making, which overcome many of these problems. U.S. Pat. No. 6,607,614 discloses the electrolytic amorphous non-laminar phosphorous alloys and the processes for making, and hereby is incorporated by reference in its entirety.

Also, recent advances have been made in electroless coatings involving coatings incorporating various particulate matter. These particulate matter can alter or impart additional characteristics to the electroless coating. However, as noted above, the inherent limitations on electroless coatings still can lead to undesired outcomes such as discrete cites of crystalline structures which are problematic for diamond turning applications.

Accordingly, the need exists for improved metal articles and for articles with improved metal surfaces. Thus, the need exists for improved alloys co-deposited with particulate matter for making these metal articles and metal surfaces.

### SUMMARY OF THE INVENTION

Those needs are met by the present invention. Thus, the present invention provides amorphous nickel phosphorous alloys, amorphous nickel cobalt phosphorous alloys, and amorphous cobalt phosphorous alloys, all of which are co-deposited with particulate matter. Typically, these alloys have a phosphorous content of between about 10% and about 20% in order to assure that an amorphous alloy is being formed.

One aspect of the present invention is an amorphous nickel phosphorous alloy co-deposited with particulate matter produced by electrodeposition of the alloy. Another aspect of the present invention is an amorphous nickel cobalt phosphorous alloy co-deposited with particulate matter produced by electrodeposition of the alloy. Yet another aspect of the present invention is an amorphous cobalt phosphorous alloy co-deposited with particulate matter produced by electrodeposition of the alloy.

The present invention further provides articles and/or devices formed by electroplating the amorphous phosphorous alloys co-deposited with particulate matter of the present invention onto a surface such as a substrate or substrate mandrel.

Further provided is a method of preparing the amorphous nickel phosphorous alloys, amorphous nickel cobalt phosphorous alloys, or amorphous cobalt phosphorous alloys co-deposited with particulate matter by a) providing a bath consisting of nickel ions, cobalt ions, or combinations thereof; phosphorous ions and particulate matter mixed with a suitable anionic or cationic surfactant; b) immersing a surface, which may be a substrate or a substrate mandrel, as a cathode into the bath; c) immersing an anode into the bath; and d) applying an electrical potential across the anode and cathode so as to effect electrodeposition of the alloy onto the surface.

### DETAILED DESCRIPTION OF THE INVENTION

The present invention provides amorphous nickel phosphorous alloys, amorphous nickel cobalt phosphorous alloys, and amorphous cobalt phosphorous alloys, all of which are co-deposited with particulate matter. In addition, the present invention provides articles and/or devices formed by electroplating a surface such as a substrate or substrate mandrel with the amorphous phosphorous alloys co-deposited with particulate matter according to the present invention.

In the preferred embodiment of the present invention, articles and/or devices are provided which have been electroformed from an amorphous non-laminar phosphorous alloy co-deposited with particulate matter. The amorphous non-laminar phosphorous alloy comprises an alloy chosen from the group consisting of nickel phosphorous alloys, nickel cobalt phosphorous alloys and cobalt phosphorous alloys. In another embodiment, the articles and/or devices are formed by electroplating suitably-dimensioned, load-bearing substrates and/or substrate mandrels with the amorphous non-laminar phosphorous alloys co-deposited with particulate matter of the present invention.

The term “particulate matter” as used herein is intended to encompass finely divided particulate matter, generally in the average size range of about 0.1 micron to about 150 microns. One exemplary range of particulate matter average particle size is from about 0.5 micron to about 10 microns, and more preferably less than 5 microns, and most preferably less than 1 micron. These particulate matter particles are generally insoluble or sparingly soluble within the electroplating composition. These materials may be selected from a wide variety of distinct matter such as ceramics, glass, talcum, plastics, diamond (polycrystalline or monocrystalline types), graphite, oxides, suicides, carbonates, carbides, sulfides, phosphates, borides, silicates, oxylates, nitrides, fluorides of various metals, as well as metal or alloys of boron, tantalum, stainless steel, chromium, molybdenum, vanadium, zirconium, titanium, and tungsten. Exemplary particulate matters include diamond, boron nitride, aluminum oxide, tungsten carbide, silicon carbide and polytetrafluoroethylene.

In one exemplary embodiment, the particulate matter is suspended within the electrolytic bath during the deposition process and the particles are co-deposited with the amorphous non-laminar alloys of the present invention. The particulate matter co-deposited may serve any of several functions, including lubricity, wear, abrasion, and corrosion applications and combinations thereof. These materials are generally inert with respect to the electrolytic plating solution.

In one exemplary embodiment, the particulate matter loading in the electroplating solution ranges from about 0.1 grams/liter to about 100 grams/liter.

In another embodiment of the present invention, after deposition of the alloy and particulate matter, the surface is heat treated. It is believed that this heat treatment helps improve adhesion of the coating to the substrate and hardening of the alloy. Exemplary heat treatment ranges from about 400° F. to about 800° F. for a period of about one (1) hour to about six (6) hours. In one embodiment, the heat treatment comprises about 590° F. for a period of about three (3) hours.

In embodiments of the present invention wherein the amorphous phosphorus alloys co-deposited with particulate matter of the present invention are electroformed on suitably-dimensioned substrates as the surface, exemplary substrate components comprise any material which has sufficient load bearing capabilities to retain its dimensions when plated with the alloy and which may be fashioned into dimensions suitable for forming the article and/or device. As used herein, the term “suitably-dimensioned” means fabricated to the nominal dimensions, shape or contour of the desired high-precision device to be formed. Examples of suitable substrates are substrates composed of metals, such as aluminum, stainless steel, copper, beryllium, molybdenum, nickel, steel, and the like, substrates composed of metal alloys, such as beryllium-copper, various brass or bronze alloys, and the like, as well as composite such as carbon composites, graphite composites and carbon/epoxy composites, plastic, glass, ceramics, ceramic alloys, and the like. In cases where the substrate component is composed of metal or a metal alloy, the substrate component may be suitably-dimensioned by the usual ways well known in the metal working industry, including metal removal via milling, grinding, lathe turning, fly cutting or spark erosion by electrical discharge. In cases where the substrate component is composed of a composite, the substrate component may be suitably-dimensioned by, for example, molding techniques. Typically, the substrate component is fabricated to suitable dimensions anywhere from about 0.001″ to about 0.100″ or more undersize depending on the design, application and surface finish requirements of the article and/or device to be formed.

In embodiments of the present invention wherein the amorphous phosphorus alloys co-deposited with particulate matter of the present invention are electroformed on suitably-dimensioned substrate mandrels as the surface, exemplary substrate components comprise any material which has sufficient load bearing capabilities to retain its dimensions when plated with the alloy and whose surface is suitable for the end-application of the article and/or device. For example, when the article and/or device is to be a high precision device, the surface of the suitably-dimensioned mandrel must be precisely-dimensioned or have a surface which may be fashioned to precise dimensions. As used herein, the term “precisely dimensioned” means suitable as a high precision device or suitable for forming a high precision device without the need for further fabrication. Examples of suitable substrate mandrels are substrate mandrels composed of materials which include glass, stainless steel, wax, aluminum, nickel, copper and the like. Prior to plating, the suitable substrate mandrel for use in the embodiment which involves electroplating a substrate mandrel is first suitably-dimensioned, is fabricated to form the nominal dimensions, shape or contour of the article and/or device to be formed by methods well known to those skilled. If the article and/or device is to be a high precision device, the surface of the suitably-dimensioned substrate mandrel may is then fashioned into a precisely-dimensioned surface by procedures and techniques well-known in the art, for example, by high precision tooling techniques. Examples of substrate mandrels are substrate mandrels composed of metals, such as stainless steel, nickel, copper and the like. Alternatively, the substrate mandrel may be initially formed in such a way that the substrate mandrel has a precisely-dimensioned surface without the need for further fabrication. Examples of substrate mandrels which are formed in such a way that they have a precisely-dimensioned surface without the need for further fabrication are substrate mandrels which themselves have been formed from a mold or mandrel having a precisely-dimensioned surface. Such substrate mandrels could be formed by molding techniques well known in the art or by plating and separating techniques as taught herein. Alternatively, the substrate mandrel may be formed from a material which inherently results in a precisely-dimensioned surface without the need for further fabrication. Examples of substrate mandrels which are composed of materials such that they have a precisely-dimensioned surface without the need for further fabrication are glass, wax, epoxy composites, graphite composites, epoxy-graphite composites, ceramics, plastics and the like.

The suitably dimensioned substrate component or suitably-dimensioned substrate mandrel is then plated with an amorphous nickel phosphorous alloy, amorphous cobalt phosphorous alloy, or amorphous nickel cobalt phosphorous alloy, all of which are co-deposited with particulate matter by means of electrodeposition. Portions of the suitably-dimensioned substrate component or suitably-dimensioned load-bearing substrate mandrel where plating is not desired are masked off by the use of plater's tape or special paints, as is well known in the electroplating industry.

In one embodiment of the present invention wherein the amorphous phosphorous alloy co-deposited with particulate matter which has been deposited on a suitably-dimensioned substrate is subjected to conventional finishing techniques and procedures, the alloy may be deposited to any thickness which is suitable for the design, application and surface finish requirements of the high precision device to be formed and will typically be a thickness of approximately 0.0005 inches to approximately 0.1 inches. In embodiments of the present invention wherein the alloy is subjected to high precision tooling, the alloy may be deposited to any thickness which is suitable for the design, application and surface finish requirements of the high precision device to be formed and will typically be a thickness of approximately 0.005 inches to approximately 0.030 inches.

In one embodiment of the present invention which involves electroplating a suitably-dimensioned substrate mandrel with the amorphous phosphorous alloys co-deposited with particulate matter, the alloy is deposited to a thickness which is not only suitable for the requirements of the article and/or device to be formed, but which is also thick enough to give sufficient support and rigidity to the article and/or device and will typically be in the range of approximately 0.001 inches to approximately 0.5 inches.

Prior to electroplating, the suitably-dimensioned substrate component or suitably-dimensioned substrate mandrel is appropriately fixtured to insure a good electrical connection to the cathode or negative pole of a rectifier. The substrate component or substrate mandrel is then prepared for electroplating by conventional pretreatment procedures and techniques well known in the art. For example, when the substrate component or substrate mandrel is composed of stainless steel, the substrate component or substrate mandrel may be bead blasted with a fine grit glass bead, immersed in a hot alkaline soak cleaner for about 10-15 minutes, thoroughly rinsed in deionized water, immersed in about 50% vol. hydrochloric acid for approximately 3-5 min, thoroughly rinsed in deionized water, immersed in a sulfuric acid etch solution and made anodic at about 200-300 A.S.F. for approximately 30-45 sec., thoroughly rinsed in deionized water, the hot alkaline electrocleaner step repeated, thoroughly rinsed in deionized water, immersed in 50% hydrochloric acid for approximately 30-90 sec., thoroughly rinsed in deionized water, immersed in Wood's nickel strike (32 oz/gal NiCl and 16 fl. oz/gal HCl, ambient temp.) and made cathodic at a current density of about 50 to about 75 A.S.F for approximately 3-5 minutes and then thoroughly rinsed in deionized water. When the substrate component or substrate mandrel is composed of glass, for example, conventional pretreatment methods used in the “plating on plastics” industry may be utilized. For example, the glass surface may be seeded with palladium and a thin film of electroless nickel deposited on the surface to serve as an electroplate base. Alternatively, the glass surface could be sprayed with a conductive paint.

An amorphous non-laminar nickel phosphorous alloy co-deposited with particulate matter is plated onto the substrate component or substrate mandrel by immersing the pretreated substrate component or substrate mandrel in a nickel/phosphorous electroplating solution containing particulate matter at a cathode current density of approximately 25-50 A.S.F. for a period of time sufficient to deposit the required thickness of alloy coating. The electrolytic solution is initially operated with inert anodes under standard parameters. At a cathode current density of approximately 50 A.S.F., a typical average deposition rate will be approximately 0.001″ per hour.

The nickel/phosphorous electroplating solution is composed of about 0.5 to about 1.4M nickel as metal, about 0.5 to about 4.0M phosphorous acid, and about 1.0 to about 3.0M chloride ion. The electroplating solution also comprises from about 0.1 grams/liter to about 100 grams/liter of particulate matter. The chloride salts also serve to supply chloride ions which aid in the prevention of metal oxide films on the anode. The electroplating solution also preferably includes an anionic or cationic surfactant. A surfactant is useful in that it gives the particles all the same electrical charge, which causes them to repel each other and keep from forming agglomerations in the plating solution. The electrolytic solution may also contain additional components to aid in the electroplating process. Examples of such additional components are buffers, wetting agents, surfactants, particulate matter stabilizers, and the like. During the operation of the bath, anywhere from about 0 to about 4.0M phosphoric acid may be generated as a by-product that forms from the oxidation of the phosphorous acid at the anode. The rate of buildup of phosphoric acid is dependent upon the type of anode arrangement used and the anode current density during operation. Small amounts of phosphoric acid (approximately 0.3-1.0M) result in increased brightness and leveling capabilities of the deposit. Amounts of phosphoric acid over 1.0M do not have a deleterious effect on the electrodeposition and the concentration of phosphoric acid soon reaches an equilibrium condition where either buildup equals removal from dragout or a saturation condition is reached. The phosphorous ions are supplied by the phosphorous acid. The nickel metal is initially supplied with nickel salts, such as nickel chloride or nickel carbonate and are monitored frequently during the electroplating process with standard EDTA titration. When the nickel concentration reaches approximately 0.9M, additional nickel ions may be supplied by either the addition of nickel salts or by the use of a nickel anode in conjunction with an anode of inert material. Suitable inert anodes are anodes composed of platinum or rhodium as is described in U.S. Pat. No. 4,786,390, which is hereby incorporated by reference, or composed of any conductive nonmetal materials capable of withstanding the solution environment and operating conditions, such as ceramic, graphite, and the like. Where the nickel ions are maintained by the use of a nickel anode in conjunction with an anode of inert material, the nickel and inert anode may either be continuously alternated in the electroplating solution, or both nickel and inert anodes may be used at the same time with the use of rheostats to control the proper amount of current to each anode material to maintain the desired nickel ion concentration. Typically, when nickel and inert anodes are used at the same time, approximately 80% of the current is directed to the nickel anode and approximately 20% is directed to the inert anode. The nickel anodes and inert anodes are suspended in the electrolytic solution on separate conductors (buss bar). Each conductor is then connected to the positive pole of a DC rectifier with a separate rheostat connected between the positive pole and each separate conductor. The total output current for the positive pole of the rectifier is then varied between the different anodes to achieve an equilibrium condition in which the nickel metal in the electrolytic solution is maintained at a constant value. When nickel and inert anodes are used alternatively, when the nickel ions reach approximately 0.9M, the inert anode initially used is removed and nickel anodes in the form of nickel rounds or squares in titanium baskets are then placed in the bath. When the nickel concentration reaches approximately 1.1M, the nickel anodes are replaced with inert anodes. This cycle is then continually repeated. The frequency at which the anodes are alternated depends on the amount of surface area of the substrate component or substrate mandrel and coating thickness deposited per gallon of plating solution.

Typical operating temperatures are between about 125° F. to about 180° F., alternatively from about 150° F. to about 170° F. and alternatively from about 158° F. to about 165° F. The surface tension of the bath is monitored with the use of a tension meter and may optionally be controlled with the addition of a sulfate free surfactant.

The preferred amorphous non-laminar nickel phosphorous alloys of the present invention may be produced by maintaining the cathode efficiency between about 4 to about 10 mg/amp min. In addition, an amorphous non-laminar nickel phosphorous alloy of the present invention with a phosphorous content of between about 10% and about 13% may be produced by maintaining the cathode efficiency between about 6 to about 9 mg/amp. min. while an amorphous non-laminar nickel phosphorous alloy of the present invention with a phosphorous content between about 13% and about 15% may be produced by maintaining the cathode efficiency between about 4 to about 6 mg/amp. min. Cathode efficiency can be controlled by altering the chloride content or temperature of the solution. The cathode efficiency is increased by raising either the chloride content or raising the operating temperature. Alternatively, it can be lowered by decreasing the chloride content or operating temperature.

In addition, amorphous non-laminar nickel phosphorous alloys of the present invention with a phosphorous content between about 16% and about 20% may be prepared by utilizing the plating conditions described above for preparing an amorphous non-laminar nickel phosphorous alloy of the present invention with a phosphorous content between about 13% and about 15%, but modifying the direct current wave form out of the rectifier by techniques and procedures well known to one of ordinary skill in the art. For example, the direct current wave form is modified out of the rectifier may be accomplished by pulse plating or periodic reverse plating. In pulse plating, the DC current is interrupted periodically (turned on and off). The on and off times are typically in the millisecond to second range and the on/off times can be adjusted separately. This allows the cathode diffusion (boundary) layer to be more thoroughly replenished with ions from the bulk of the solution during the off cycle, reduces polarization tendencies, and helps to keep the concentration of H₃PO₃ at the cathode diffusion layer at the optimum concentration, thereby increasing the amount of phosphorous in the deposit. Periodic reverse plating involves altering the direct current wave form out of the rectifier by alternatively changing the polarity of the electrodes from positive to negative at adjustable time intervals, typically in the millisecond to second range. The substrate or substrate mandrel is typically made the cathode or negative electrode for a longer time or it is subjected to a higher current density than it normally would be if it were made the anode or positive electrode. By preferentially removing nickel from the deposit while the part is on the reverse (positive or anodic) part of the cycle, the phosphorous content of the deposit is increased.

Using the above techniques of adjusting the cathode efficiency and modifying the direct current wave form out of the rectifier, amorphous nickel phosphorous alloys of the present invention may be produced which have a phosphorous content of between about 10% and about 20%. Typical phosphorous contents of the alloys within that range include all of the sub-ranges, i.e. from about 10% to about 11%; to about 19% to about 20%, and everything inbetween.

As stated previously, nickel/phosphorous alloys having a phosphorous content of between about 10% and about 13% can become slightly magnetic when exposed to temperatures in the range of 250° C. and 300° C. Such temperatures are typically encountered in the manufacture of memory disks. Therefore, memory disks manufactured using nickel/phosphorous alloys having a phosphorous content of between about 11% and about 13% may become slightly magnetic during the manufacturing process and must be rejected. However, memory disks manufactured using nickel/phosphorous alloys having a phosphorous content of about 13% or higher do not have the same tendency to become magnetic when exposed to temperatures in the range of 250° C. and 300° C. Therefore, the amorphous nickel/phosphorous alloys of the present invention having a phosphorous content of about 13% or higher are particularly suited to the manufacture of memory disks. Thus, the amorphous nickel/phosphorous alloys of the present invention having a phosphorous content of about 13% to about 15% are particularly well-suited to the manufacture of memory disks, while the amorphous nickel/phosphorous alloys of the present invention having a phosphorous content of about 16% to about 20% are especially well-suited to the manufacture of memory disks.

When an amorphous cobalt phosphorous alloy co-deposited with particulate matter of the present invention is to be plated onto the substrate component or substrate mandrel, the procedure is identical to that described above for amorphous nickel phosphorous alloy co-deposited with particulate matter, but substituting cobalt ions for nickel ions and cobalt anodes for nickel anodes. Cobalt ions are typically supplied with cobalt salts, such as cobalt carbonate or cobalt chloride. The phosphorous content of the amorphous cobalt phosphorous alloys may be adjusted as described previously for the amorphous nickel phosphorous alloys and results in the preparation of amorphous cobalt phosphorous alloys typically having a phosphorous content of between about 10% and about 20%.

When an amorphous nickel cobalt phosphorous alloy co-deposited with particulate matter of the present invention is to be plated onto the substrate component or substrate mandrel, the procedure is also identical to that described above for amorphous nickel phosphorous alloy co-deposited with particulate matter, but approximately 25% of the nickel content is substituted by cobalt, such as cobalt salts as indicated above. The phosphorous content of the amorphous nickel cobalt phosphorous alloys may be adjusted as described previously for the amorphous nickel phosphorous alloys and results in the preparation of amorphous nickel cobalt phosphorous alloys typically having a phosphorous content of between about 10% and about 20%.

In the embodiment of the present invention wherein the amorphous phosphorous alloys co-deposited with particulate matter has been deposited on a suitably-dimensioned substrate is subjected to either conventional finishing techniques and procedures or to high precision tooling after being plated onto the substrate component, the substrate component is unmasked and the alloy coated substrate component is “rough machined” to dimensions which are “close” to the final dimensions desired on the article and/or device. Techniques for such “rough machining” are well known to those in the art, and include CNC machining. The alloy coated substrate component is then subjected to either conventional techniques, such as grinding, lapping and other conventional machining techniques and procedures or to high precision tooling. As used herein, the term “high precision tooling” refers to any technique suitable for fabricating a highly precise surface and includes techniques such as hard tool turning, such as diamond turning or machining with various ceramic cutting tools or ceramic alloy cutting tools. The choice of technique depends upon the final quality, accuracy and surface finish requirements of the final high precision device to be formed. Therefore, in contrast to conventional hard chrome plating which requires a polishing and/or grinding step both before and after electroplating, electroplating a substrate with the alloys of the present invention does not require either a pre-plating or post-plating polishing step, but merely requires a post-plating machine-finishing step. In addition, it has been found that sub-micron particles of polytetrafluoroethylene (Teflon) co-deposited with an alloy such as nickel/phosphorous pursuant to the present invention will reduce diamond tool wear during diamond turning.

In the embodiment of the present invention which involves electroplating a suitably-dimensioned substrate mandrel with the amorphous phosphorous alloys co-deposited with particulate matter of the present invention, after plating the alloy onto the substrate mandrel, the amorphous phosphorous alloy co-deposited with particulate matter is separated from the substrate mandrel to give the article and/or device. The initial layer of deposit formed is an exact replica of the substrate mandrel surface and is therefore, if the surface of the substrate mandrel is precisely-dimensioned, the article and/or device so formed is precisely dimensioned. The amorphous phosphorous alloys co-deposited with particulate matter of the present invention exhibit an internal stress which is very low, being approximately 2000 lbs tensile to about 3000 lbs compressive. This very low internal stress allows the alloys of the present invention to be released from the substrate mandrel without distortion.

As stated previously, the alloys of the present invention are particularly useful for making metal articles and articles with metal-coated surfaces whose end-application requires lubricity, hardness and wear-resistance, and corrosion-resistance, such as molds and molding inserts. For example, molds formed from the alloys of the present invention or coated with the alloys of the present invention are particularly well-suited for molding plastics and may be used to fabricate high pressure injection molds, compression molds, thermoset molds, replication molds, electroforming molds, and the like. The natural lubricity of the alloys of the present invention results in the plastic being more easily removed from the mold or molding insert. This in turn results in reduced cycle times and an overall increase in the production of the molded plastic product.

The amorphous structure of the alloys of the present invention renders then particularly suitable for the fabrication of high precision devices formed by hard-tool turning applications. Because the alloys are amorphous, the quality of the alloy deposit is consistent throughout the deposit. Hence, there is no tendency for the formation of “banding” or demarcation lines after hard-tool turning. In addition, the high phosphorous content of the alloys of the present invention also makes them particularly well-suited to hard-tool turning applications, with the alloys of the present invention having a phosphorous content of between about 13% and about 15% being particularly preferred, and those having a phosphorous content of between about 16% and about 20% being especially preferred. Further, the alloys of the present invention, being amorphous in structure (i.e., no crystalline or grain structure discernible at 150,000. times.), are particularly well-suited to hard-tool turning in that the required surface finish is more easily obtained than with a non-amorphous metal or metal alloy, such as aluminum, copper, and stainless steels.

Further, the amorphous phosphorous alloys co-deposited with particulate matter of the present invention are useful in resurfacing or repairing metal surfaces. After any necessary surface-treatment steps (e.g., machining away the damaged areas on the metal surface to be repaired), at least a portion of the damaged surface is electroplated with the amorphous phosphorous alloys co-deposited with particulate matter of the present invention using techniques and procedures described previously. If necessary, the electroplated alloy may then be machined or subjected to high precision tooling as described previously. The amorphous phosphorous alloys co-deposited with particulate matter of the present invention may be used to repair any metal or metal alloy surface.

Repairs to damaged metal surfaces made with the amorphous phosphorous alloys co-deposited with particulate matter of the present invention are superior to traditional metal-surface repairing techniques. Because the alloys of the present invention are more dense, more pure, and more defect-free than traditional repairing materials (e.g., inserts, welds, and plating), the repair is virtually defect-free, exhibiting few pits and/or inclusions. In addition, because the alloys of the present invention are particularly well-suited to hard tool turning, the repaired article may be hard tool turned to a superior mirror finish without the need for polishing steps before and after the plating steps. In addition, unlike repairs made with hard chrome, repairs made with the alloys of the present invention may be finished by remachining techniques rather than time-consuming regrinding techniques.

Further, the amorphous phosphorous alloys co-deposited with particulate matter of the present invention may be deposited at a speed of about 0.001″ per hour, making them particularly well-suited for commercial use. In addition, because the time required to deposit the alloys to the required thickness is shortened, particulate matter is easily kept out of the electroplating solution and the resulting alloys exhibit increased purity over alloys formed by slow deposition speeds.

Finally, although particularly well-suited for the fabrication of article and/or devices, including molds, molding inserts, and high precision devices, and for the repairing of metal surfaces, the alloys of the present invention are also suitable for such conventional purposes as decorative and protective purposes and for any purpose wherein a property and/or combination of properties exhibited by the alloys of the present invention is required or desired.

### EXAMPLE

In this Example, 4″×4″ test panels were prepared according to the present invention (test panels 1C, 1D, 2A-5B, 6C, and 6D). In addition, comparative test panels containing no co-deposited particulate matter were prepared (Test panels 1A, 1B, 6A and 6B). Table 1 discloses the test panel parameters and results for the experiment. The test panels were subjected to testing to determine the Taber Wear Index (TWI). The TWI is a test utilized in the electroplating industry to test resistance to abrasion and wear. The test is disclosed under Taber Abrasion per Method 6192 of Fed-STD-141C, ASTM D 4060-90. The test comprises placing a 4″×4″ test panel in a specialized machine and then applying an abrasive wheel under a specified load for a specified number of revolutions. The test panel is weighed before and after the test. The test panel with the least amount of weight loss is considered to be best as far as wear resistance is concerned. The test panels were also subjected to an adhesion test comprising a 90° bend well known to one skilled in the art. In addition, each test panel was subjected to a salt spray test under ASTM B117.

For test panels 1A-4B the plating thickness was 0.0015″ to 0.002″. For test panels 5A and 5B the plating thickness was 0.0015″. For test panels 6A-6D the plating thickness was 0.001″ to 0.0015″.

TABLE 1

| | | | | Salt Spray | |
|---|---|---|---|---|---|
| Test | | | Adhesion | Result | TWI |
| Panel | Particle | Post-heat | Test | ASTM | 1000 |
| ID | Loading | treatment | 90° bend | B117 | Cycles |
| 1A | None | None | Pass | 100 hours | 12.2 |
| 1B | None | 590° F. | Pass | 100 hours | 8.3 |
| | | 3 hours | | | |
| 1C | 20 grams/liter | None | Pass | 100 hours | 3.1 |
| 1C | Silicon carbide | None | Pass | 100 hours | 3.1 |
| 1D | 20 grams/liter | 590° F. | Pass | 100 hours | 0.9 |
| | Silicon carbide | 3 hours | | | |
| 2A | 75 grams/liter | None | Pass | 100 hours | 4.1 |
| | Diamond | | | | |
| 2B | 75 grams/liter | 590° F. | Pass | 100 hours | 1.6 |
| | Diamond | 3 hours | | | |
| 3A | 30 grams/liter | None | Pass | 100 hours | 4.68 |
| | Silicon carbide | | | | |
| 3B | 30 grams/liter | 590° F. | Pass | 100 hours | 2.82 |
| | Silicon Carbide | 3 hours | | | |
| 4A | 7.5 grams/liter | None | Pass | 100 hours | 16.97 |
| | Sodium | | | | |
| | borohydride | | | | |
| 4B | 7.5 grams/liter | 590° F. | Pass | 100 hours | 9.40 |
| | Sodium | 3 hours | | | |
| | borohydride | | | | |
| 5A | Standard | None | Pass | 100 hours | 9.0 |
| | Teflon | | | | |
| 5B | Standard | 590° F. | Pass | 100 hours | 9.9 |
| | Teflon | 3 hours | | | |
| 6A | None | None | Pass | 100 hours | 7.20 |
| 6B | None | 590° F. | Pass | 100 hours | 6.95 |
| | | 3 hours | | | |
| 6C | 50 grams/liter | None | Pass | 100 hours | 2.95 |
| | Silicon carbide | | | | |
| 6D | 50 grams/liter | 590° F. | Pass | 100 hours | 2.20 |
| | Silicon carbide | 3 hours | | | |

As can be seen from the results in Table 1, test panels containing silicon carbide had the greatest improvement in resistance to abrasion and wear as exemplified by the lower TWI. In addition, the post deposition heat treatment step also resulted in improved TWI.

The foregoing examples and description of the various embodiments of the invention has been presented for the purposes of illustration and description. It is not intended to be exhaustive or limit the invention to the precise form disclosed. Many alternatives, modifications, and variations will be apparent to those skilled in the art of the above teaching. Accordingly, this invention is intended to embrace all alternatives, modifications, and variations that have been discussed herein, and others that fall within the spirit and broad scope of the claims.

What is claimed is:

1. A method of preparing an amorphous nickel phosphorous alloy, amorphous nickel cobalt phosphorous alloy or an amorphous cobalt phosphorous alloy having a phosphorus content of between 10% and about 20%, co-deposited with particulate matter, the method comprising:
providing a bath consisting of nickel ions, cobalt ions, or combinations thereof, a sufficient amount phosphorous ions to produce an alloy having a phosphorous content of between about 10% and about 20%, and particulate matter mixed with an anionic or cationic surfactant;
immersing a surface as a cathode into the bath;
immersing an anode into the bath; and
applying electrical potential across the anode and cathode so as to effect electrodeposition of the alloy onto the substrate to produce a coated substrate surface.

2. The method of claim 1, wherein the particulate matter has a loading ranging from about 0.1 grams/liter to about 100 grams/liter of the bath.

3. The method of claim 1, wherein an amorphous, non-laminar alloy is produced while maintaining a cathode efficiency at range of between about 4 and about 10 mg/amp. min.

4. The method of claim 1 wherein the particulate matter comprises diamond, boron nitride, aluminum oxide, polytetrafluoroethylene, tungstein carbide, silicon carbide, or combinations thereof.

5. The method of claim 1 further including the step of heating said coated surface from about 400° F.-to about 800° F.

6. The method of claim 5, wherein said coated surfaces heated for a period of about one to about six hours.

7. An amorphous nickel phosphorous alloy having a phosphorous content of between about 10% and about 20%, co-deposited with particulate matter produced by electrodeposition of the alloy.

8. The amorphous nickel phosphorous alloy of claim 7, wherein the alloy is an amorphous, non-laminar alloy characterized by the absence of a plurality of thick, parallel lines or regions in cross-sectional photomicrographs of the alloy after electrodeposition.

9. The amorphous nickel phosphorous alloy of claim 7, wherein the particulate matter comprises diamond, boron nitride, aluminum oxide, polytetrafluorethylene, tungsten carbide, silicon carbide, or combinations thereof.

10. The amorphous nickel phosphorous alloy of claim 7, wherein the particulate matter ranges from about 0.1 microns to about 150 microns in size.

11. An amorphous nickel cobalt phosphorous alloy having a phosphorous content of between about 10% and about 20% co-deposited with particulate matter produced by electrodeposition of the alloy.

12. The amorphous nickel cobalt phosphorous alloy of claim 11 wherein the particulate matter comprises diamond, boron nitride, aluminum oxide, polytetrafluorethylene, tungsten carbide, silicon carbide, or combinations thereof.

13. The amorphous nickel cobalt phosphorous alloy of claim 11 wherein the alloy is an amorphous, non-laminar alloy characterized by the absence of a plurality of thick, parallel lines or regions in cross-sectional photomicrographs of the alloy after electrodeposition.

14. An amorphous cobalt phosphorous alloy having a phosphorous content of between about 10% and about 20% co-deposited with particulate matter produced by electrodeposition of the alloy.

15. The amorphous cobalt phosphorous alloy of claim 14 wherein the alloy is an amorphous, non-laminar alloy characterized by the absence of a plurality of thick, parallel lines or regions in cross-sectional photomicrographs of the alloy after electrodeposition.

16. The amorphous cobalt phosphorous alloy of claim 14 wherein said coated surfaces heated for a period of about one to about six hours.

17. An article or device having a surface with an amorphous Ni/P alloy, amorphous Ni/Co/P alloy, or amorphous non-laminar Co/P alloy each having a phosphorous content between about 10% and about 20%, wherein said alloy is deposited thereon produced by electrodeposition of the alloy on the surface; and further comprising particulate matter co-deposited with the alloy.

18. The article or device of claim 17 wherein, the alloy is an amorphous, non-laminar alloy characterized by the absence of a plurality of thick, parallel lines or regions in cross-sectional photomicrographs of the alloy after electrodeposition.

19. The article or device of claim 17 wherein said coated surfaces heated for a period of about one to about six hours.

20. The article or device of claim 17 wherein said alloy has a phosphorous content of between about 13% and about 20%.

21. The article or device of claim 17 wherein said particulate matter comprises particles having an average size of less than 5 microns.

22. The article or device of claim 21 wherein said particles are polytetrafluoroethylene particles having an average size of less than 1 micron.

23. The article or device of claim 17 wherein said article or device is a lenticular or rotogravure cylinder or a lenticular or rotogravure mold.

24. The article of claim 23 wherein the particulate matter comprises diamond, boron nitride, aluminum oxide, polytetrafluoroethylene, tungsten carbide, silicon carbide, or combinations thereof.

25. The article of claim 23 wherein the particulate matter is polytetrafluoroethylene particles having an average size of less than 1 micron.
